(19) United States
(12) Patent Application Publication
(10) Pub. No.: US 2020/0256503 A1
(43) Pub. Date: Aug. 13, 2020

(54) LAMINAR JACKETS FOR FLEXIBLE DUCTS OF HVAC SYSTEMS

(71) Applicant: Air Distribution Technologies IP, LLC, Milwaukee, WI (US)

(72) Inventors: Jon L. Hulsebus, Grandville, MI (US); Robert G. Owens, II, Shepherdsville, KY (US)

(21) Appl. No.: 16/356,767

(22) Filed: Mar. 18, 2019

Related U.S. Application Data
(60) Provisional application No. 62/803,163, filed on Feb. 8, 2019.

(51) Int. Cl. F16L 59/02; F16L 11/08; B29C 63/06

(52) U.S. Cl. CPC F16L 59/021; B29C 63/06; F16L 11/08

(57) ABSTRACT

A laminar jacket for a flexible duct of a heating, ventilation, and/or air conditioning (HVAC) system includes a first film defining an outer surface of the laminar jacket and a second film defining an inner surface of the laminar jacket. The laminar jacket includes a scrim retained between the first film and the second film. Additionally, the laminar jacket includes a longitudinally-extending seam between the first film and the second film that retains the laminar jacket in a tubular shape. The inner surface of the laminar jacket defines a hollow that is configured to receive insulation and that does not have the insulation disposed therein.

### CROSS-REFERENCE TO RELATED APPLICATIONS

This application claims priority from and the benefit of U.S. Provisional Application Ser. No. 62/803,163, entitled “LAMINAR JACKETS FOR FLEXIBLE DUCTS OF HVAC SYSTEMS,” filed Feb. 8, 2019, which is herein incorporated by reference in its entirety for all purposes.

### BACKGROUND

The present disclosure relates generally to heating, ventilation, and/or air conditioning (HVAC) systems, and more particularly to laminar jackets for flexible ducts of HVAC systems.

A wide range of applications exists for HVAC systems. For example, residential, light commercial, commercial, and industrial systems are used to control temperatures and air quality in indoor environments and buildings. Such systems may be dedicated to either heating or cooling, although systems are common that perform both of these functions. Very generally, these systems operate by implementing a thermal cycle in which fluids are heated and cooled to provide air flow at desired temperature to a controlled space, typically the inside of a residence or building. For example, a refrigerant circuit may circulate a refrigerant through one or more heat exchangers to exchange thermal energy between the refrigerant and one or more fluid flows, such as a flow of air.

Generally, the HVAC systems may include ducts that direct a conditioned air flow to the controlled space. Some HVAC systems may use flexible ducts to provide more freedom in positioning the flexible ducts within a building compared to rigid ducts. These flexible ducts may include a duct liner to receive conditioned air, insulation around the duct liner, and a jacket around the duct liner to protect the insulation from moisture or to improve an appearance of the flexible duct. Unfortunately, traditional manufacturing processes for these flexible ducts may consume considerable materials and time, contributing to an increase in costs for the HVAC systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as an admission of any kind.

### SUMMARY

In one embodiment of the present disclosure, a laminar jacket for a flexible duct of a heating, ventilation, and/or air conditioning (HVAC) system includes a first film defining an outer surface of the laminar jacket and a second film defining an inner surface of the laminar jacket. The laminar jacket includes a scrim retained between the first film and the second film. Additionally, the laminar jacket includes a longitudinally-extending seam between the first film and the second film that retains the laminar jacket in a tubular shape. The inner surface of the laminar jacket defines a hollow that is configured to receive insulation and that does not have the insulation disposed therein.

In another embodiment of the present disclosure, a flexible duct of a heating, ventilation, and/or air conditioning (HVAC) system includes a duct liner, insulation disposed around the duct liner, and a laminar jacket retaining the insulation therein. The laminar jacket includes a first film defining an outer surface of the laminar jacket, a second film defining an inner surface of the laminar jacket, and a scrim retained between the first film and the second film. Additionally, the laminar jacket includes a longitudinally-extending seam between the first film and the second film that retains the laminar jacket in a tubular shape. The second film is in direct contact with the insulation of the flexible duct.

In a further embodiment of the present disclosure, a method of constructing a flexible duct for a heating, ventilation, and/or air conditioning (HVAC) system includes bonding a scrim between a first film and a second film to form a laminar jacket material having a first longitudinally-extending edge and a second longitudinally-extending edge. The method includes bonding the first film at the first longitudinally-extending edge to the second film at the second longitudinally-extending edge to form a laminar jacket. The laminar jacket is a tube defining a hollow therein. The method also includes disposing a core assembly including insulation within the hollow of the laminar jacket to form the flexible duct.

Other features and advantages of the present application will be apparent from the following, more detailed description of the embodiments, taken in conjunction with the accompanying drawings which illustrate, by way of example, the principles of the application.

### BRIEF DESCRIPTION OF THE DRAWINGS

FIG. 1 is a perspective view of an embodiment of a commercial or industrial HVAC system, in accordance with an aspect of the present disclosure;

FIG. 2 is a perspective cutaway view of an embodiment of an assembly horn for constructing a flexible duct with a laminar jacket, in accordance with an aspect of the present disclosure;

FIG. 3 is a cross-sectional schematic diagram of a laminar jacket material, in accordance with an aspect of the present disclosure;

FIG. 4 is a cross-sectional schematic diagram of a portion of a laminar jacket constructed from the laminar jacket material, in accordance with an aspect of the present disclosure;

FIG. 5 is a cross-sectional schematic diagram of an embodiment of a flexible duct having the laminar jacket, in accordance with an aspect of the present disclosure; and

FIG. 6 is a flow diagram illustrating an embodiment of a process for constructing a flexible duct having the laminar jacket, in accordance with an aspect of the present disclosure.

### DETAILED DESCRIPTION

The present disclosure is directed to a laminar jacket for flexible ducts of heating, ventilation, and/or air conditioning (HVAC) systems. Flexible ducts generally fluidly couple an air handler to an outlet air vent, providing an air flow path for conditioned air to travel to a conditioned space of a building. To block or prevent ambient air from exchanging heat with the conditioned air before its delivery, the flexible ducts include insulation disposed around a duct liner. The insulation may in turn be disposed within a jacket material to block or prevent ambient moisture from accumulating in the insulation and reducing its efficiency. Unfortunately, certain jacket manufacturing processes may consume considerable time and materials. For example, narrow-width strips of multiple materials may be simultaneously helically wound around a mandrel, creating overlaps in adjacent winds of the resulting jacket that consume additional materials. The helically-wound jackets may also include a large seam length that increases adhesive usage, as well as presents increased potential opportunities for seam degradation that may permit moisture to contact the insulation.

To address these issues, the present disclosure is directed to laminar jackets that have a linear, axially-extending, or longitudinally-extending seam that provides for more efficient manufacturing and increased strength compared to helically-wrapped jackets and their associated spiral seam lengths. The laminar jacket may be constructed from a pre-formed laminar jacket material. The material may include a metalized polyester film, a clear polyester film, and a fiberglass scrim adhered between the films. Then, an adhesive may be applied on a first longitudinally-extending edge of the material, and the material may be rolled into a tubular shape in which the first longitudinally-extending edge having the adhesive contacts and seals against a second longitudinally-extending edge of the material. The resulting laminar jacket may therefore be efficiently constructed without the insulation or duct liner positioned therein. Accordingly, the insulation and the duct liner may be interference-fit within a hollow space of the laminar jacket to form flexible ducts having an improved cost, strength, and insulating efficiency suitable for a variety of HVAC systems.

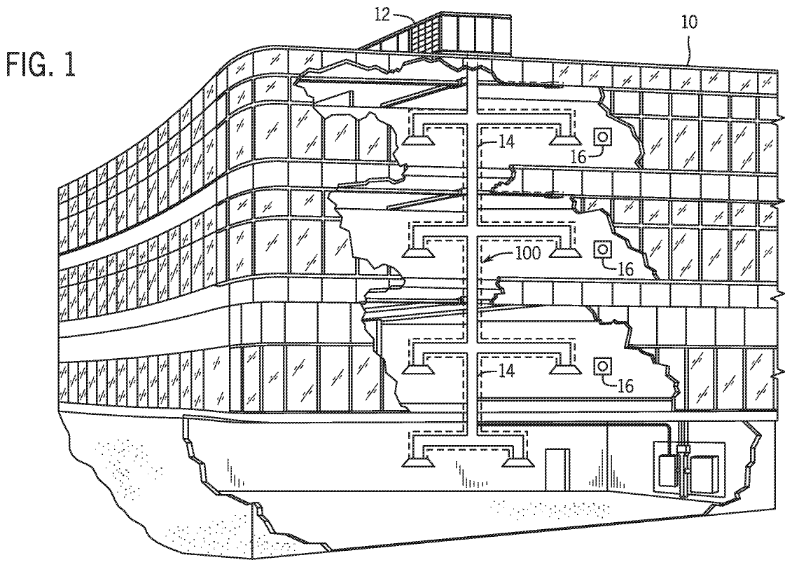

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, which includes an outdoor HVAC unit and an indoor HVAC unit.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

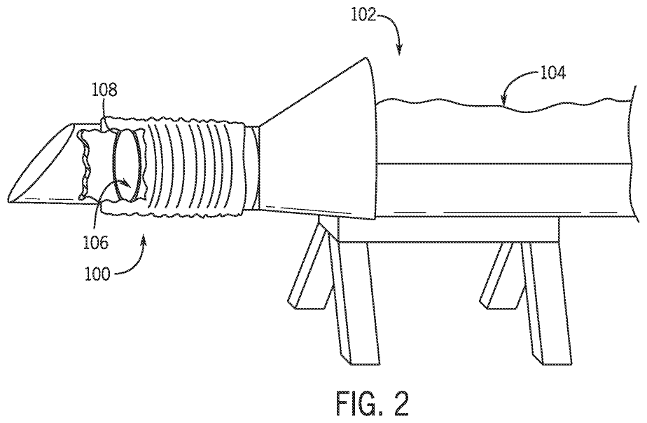

Moreover, the previously-discussed ductwork 14 may include various features to facilitate delivery of conditioned air to occupied spaces in the building 10. For example, the ductwork 14 may be generally enclosed conduits that receive the conditioned air from the HVAC unit 12 and direct the conditioned air to occupied spaces. Additionally, the ductwork 14 may reduce heat exchange and/or mass exchange between the conditioned air and ambient air through which the ductwork 14 traverses. To this end and as discussed in more detail below, the ductwork 14 may be or include flexible ductwork. The flexible ductwork may include a laminar jacket 100, such as the laminar jacket 100 illustrated in FIG. 2.

Specifically, in FIG. 2, the laminar jacket 100 is illustrated as being compacted and positioned on an assembly horn 102 that facilitates depositing insulation 104 and a duct liner 106 into the laminar jacket 100 via a through-hole 108 in the assembly horn 102, which is illustrated via a cutaway in FIG. 2. The assembly horn 102 may be any suitable sleeve or sleeving horn, including one that is fully or partially automated. In certain embodiments, an end of the insulation 104 and the duct liner 106 is compressed and moved within the through-hole 108 to align with an end of the laminar jacket 100. Then, the end of the laminar jacket 100 may be moved off the assembly horn 102 as the insulation 104 and the duct liner 106 are moved out of the through-hole 108, uncompacting the laminar jacket 100 to form a flexible duct. That is, once the laminar jacket 100 is positioned around insulation 104, which is in turn positioned around the duct liner 106, the assembled components may be utilized in or as the ductwork 14. As previously mentioned, the laminar jacket 100 includes various films or layers to fluidly separate the conditioned air moving within the ductwork 14 and the insulation from the ambient air. The laminar jacket 100 may additionally increase a structural integrity of the ductwork 14 compared to ductwork without the laminar jacket or ductwork having a multitude of helical seams, thereby improving an operating lifetime of and reducing maintenance demands for the ductwork 14. Accordingly, components and features of the laminar jacket 100 are discussed herein, followed by embodiments of a process for constructing a flexible duct with the laminar jacket 100.

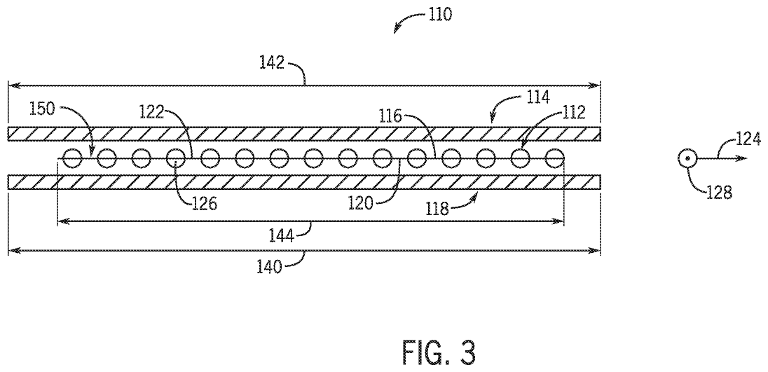

Turning now to FIG. 3, a cross-sectional schematic diagram of a laminar jacket material 110 is shown, in accordance with an aspect of the present disclosure. The laminar jacket material 110 may be used to efficiently form the laminar jackets 100 for the ductwork 14 of FIG. 1 by, for example, rolling the laminar jacket material 110 into a cylinder and coupling the adjacent edges or ends. In other embodiments, the laminar jacket material 110 may be employed for any other suitable ducts or ductwork, such as the ductwork of a residential heating and cooling system in varying geometries. As illustrated, the laminar jacket material 110 includes a scrim 112, a first film 114 positioned on a first side 116 of the scrim 112, and a second film 118 positioned on a second side 120 of the scrim 112. In the present embodiment, the scrim 112 has a rectangular net shape, in which a first portion 122 of fibers of the scrim 112 extend in a first direction 124, and a second portion 126 of the fibers of the scrim 112 extend in a second direction 128, crosswise to the first direction 124. This is schematically represented by lines that extend along direction 124 and dots that extend along direction 128 in the referenced figure. The scrim 112 may be any suitable rip-stop or net-like material, such as fiberglass, woven polyester, yarn, canvas, and the like. In other embodiments, the scrim 112 may be formed from another material having any suitable supporting properties.

Additionally, in the present embodiment, the first film 114 is a metalized polyethylene terephthalate (PET) film or polyester film, and the second film 118 is a clear PET film. The metalized PET film provides a vapor barrier to block water vapor or any other undesired molecules from traversing through the metalized PET film. However, it is to be understood that in other embodiments, one or both of the first film 114 and the second film 118 may be any suitable film, such as metalized PET, clear PET, colored PET, polyethylene, kraft paper, or any other suitable material.

Notably, the scrim 112 has a width 140 that is less than a first width 142 of the first film 114 and less than a second width 144 of the second film 118. As such, the scrim 112 is encapsulated between the films 114, 118. In other words, the scrim 112 is sandwiched between the films 114, 118, and the scrim 112 does not protrude longitudinally along the first direction 124 from between the films 114, 118. The scrim 112 may be retained between the films 114, 118 by any suitable adhesive applied on any of the first film 114, the second film 118, and/or or the scrim 112. For example, the present embodiment of the laminar jacket material 110 includes the scrim 112 separated from the films 114, 118 by an adhesive 150. The adhesive 150 may be a water-based glue, an epoxy, or any other suitable adhesive. However, in other embodiments, the scrim 112 may alternatively directly contact the first film 114, the second film 118, or both.

Additionally, in some embodiments, the laminar jacket material 110 is pre-formed in a relatively large quantity, such as a quantity sufficient to produce a threshold number of laminar jackets 100. Moreover, the second width 144 of the second film 118 at least partially defines a circumference of the laminar jacket 100 formed from the laminar jacket material 110, as discussed below. In some embodiments, the second width 144 of the second film 118 is 12 inches, 36 inches, 80 inches, or any other suitable width that results in the laminar jacket 100 having a desired circumference.

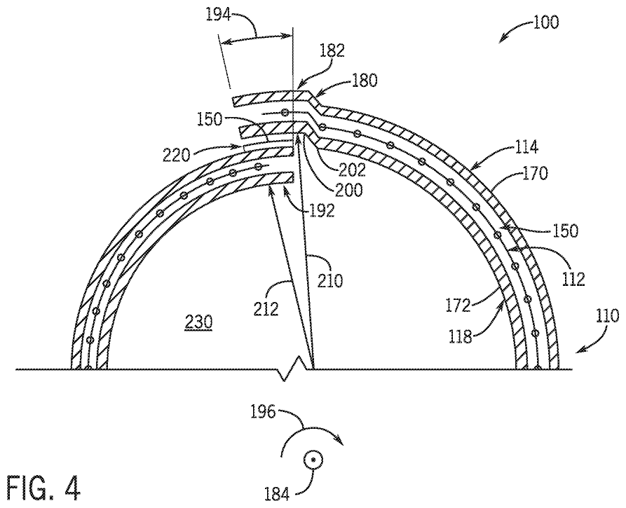

FIG. 4 is a cross-sectional schematic diagram of a portion of a laminar jacket 100 constructed from the laminar jacket material 110, in accordance with an aspect of the present disclosure. In the present embodiment, the first film 114 defines an outer surface 170 of the laminar jacket 100 and the second film 118 defines an inner surface 172 of the laminar jacket 100. Moreover, a crimp 180 is formed at a first edge 182 or first longitudinally-extending edge portion of the laminar jacket 100, which extends along a longitudinal axis 184 into the page. The crimp 180 may be overlapped with a second edge 192 or second longitudinally-extending edge portion of the laminar jacket 100 by an overlap distance 194 or engagement region defined along a circumferential axis 196. In the present embodiment, the crimp 180 includes a first bend 200 and a second bend 202 that collectively enable the first edge 182 of the laminar jacket to have a first radius 210 that is larger than a second radius 212 of the second edge 192 of the laminar jacket 100. In other embodiments, the crimp 180 may have any other suitable shape with any suitable number of bends, or the crimp 180 may be omitted. By overlapping the second film 118 at the first edge 182 with the first film 114 at the second edge 192, a linear seam 220 or longitudinally-extending seam that extends along the longitudinal axis 184 may be formed. The linear seam 220 therefore shapes the laminar jacket material 110 as a tube or cylinder that corresponds to the laminar jacket 100.

Additionally, in the present embodiment, the adhesive 150 is applied to the first film 114 at the second edge 192 of the laminar jacket material 110, thereby enabling the first film 114 to seal to the second film 118 at the linear seam 220 and form the laminar jacket 100. As such, the second width 144 of the second film 118 of the laminar jacket material 110 of FIG. 3 is equal to the circumference of the laminar jacket 100 and the overlap distance 194. In other embodiments, the adhesive 150 may additionally or alternatively be applied to the second film 118 at the first edge 182. The adhesive 150 that is applied to the edges 182, 192 may be the same adhesive as the adhesive 150 retaining the scrim 112 between the films 114, 118 or may be a different, suitable adhesive.

Notably, the inner surface 172 of the laminar jacket 100 defines a hollow 230 or chamber therein. The hollow 230 may include a longitudinal opening at each longitudinal end of the laminar jacket 100 defined along the longitudinal axis 184, thereby forming a through-hole in the laminar jacket 100. Additionally, the hollow 230 is generally cylinder-shaped in the present embodiment, though it is to be understood that the hollow 230 may alternatively have any shape that corresponds to the inner surface 172 of the laminar jacket 100. Moreover, the duct liner 106 and the insulation 104 referenced above are not within the hollow 230 when the laminar jacket 100 is formed. Instead, the duct liner 106 and the insulation 104 may be moved within a longitudinal opening of the hollow 230 during assembly of a flexible duct, enabling the laminar jacket 100 to retain the duct liner 106 and the insulation 104 via friction or an interference fit.

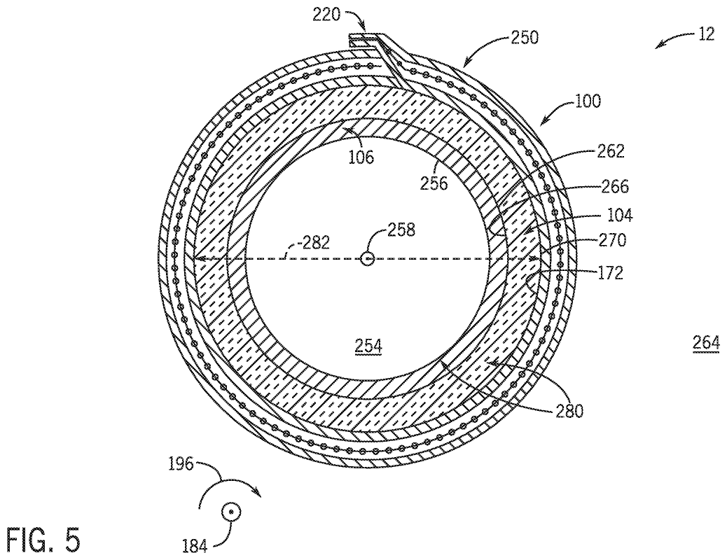

FIG. 5 is a cross-sectional schematic diagram of an embodiment of a flexible duct 250 having the laminar jacket 100, in accordance with an aspect of the present disclosure. As illustrated, the flexible duct 250 includes the duct liner 106 that defines an air flow path 254 through which the conditioned air may be directed to the interior space of the building 10. In other words, an inner surface 256 of the duct liner 106 defines the air flow path 254 therein. As used herein, an “inner” portion or element refers to a portion or element that is closer to a longitudinally-extending centerline 258 of the flexible duct 250 than an “outer” portion or element. The duct liner 106 may be a helical coil wrapped with one or more sheets of material or foil, in some embodiments. Additionally, the insulation 104 is disposed or wrapped around an outer surface 262 of the duct liner 106, providing a thermal break between the air flow path 254 and ambient air 264 outside the flexible duct 250. In some embodiments, the insulation 104 is a loose, compressible insulation that may be formed from any suitable insulating material, such as fiberglass, natural fibers, and so forth. In some embodiments, an inner surface 266 of the insulation 104 is adhered to the outer surface 262 of the duct liner 106, though in other embodiments, the laminar jacket 100 may sufficiently retain the insulation 104 in place between the duct liner 106 and the laminar jacket 100 without an adhesive disposed between the insulation 104 and the duct liner 106.

Notably, an outer surface 270 of the insulation 104 is in direct contact with the inner surface 172 of the laminar jacket 100. That is, the duct liner 106 and the insulation 104, which together may form a core assembly 280, are disposed within the hollow 230 of the laminar jacket 100 and retained within the hollow 230 without adhesive. Because the insulation 104 may be a loose or flexible insulating material, the outer surface 270 of the insulation 104 may be compressed against the inner surface 172 of the laminar jacket 100. As such, when not disposed in the laminar jacket 100, the insulation 104 may have an unassembled outer diameter that is larger than an assembled outer diameter 282 of the insulation 104 when the insulation 104 is disposed in the laminar jacket 100 under compression. The insulation 104 within the laminar jacket 100 may therefore exert a restoring force against the inner surface 172 of the laminar jacket 100, which provides an interference fit that retains the core assembly 280 in an operating position within the laminar jacket 100. The laminar jacket 100 also protects the insulation 104 from moisture that may be present in the ambient air 264 outside the flexible duct 250. Accordingly, the flexible duct 250 having the laminar jacket 100 with the linear seam 220 may provide operational benefits to the HVAC unit 12 by insulating conditioned air moving along the air flow path 254 and blocking moisture from contacting the insulation 104. Moreover, compared to a jacket with helical seams, the laminar jacket 100 may have an increased strength stemming from the comparatively-reduced seam length. With the above understanding of the components of the flexible duct 250 and the laminar jacket 100, further details for constructing the same may be more readily understood.

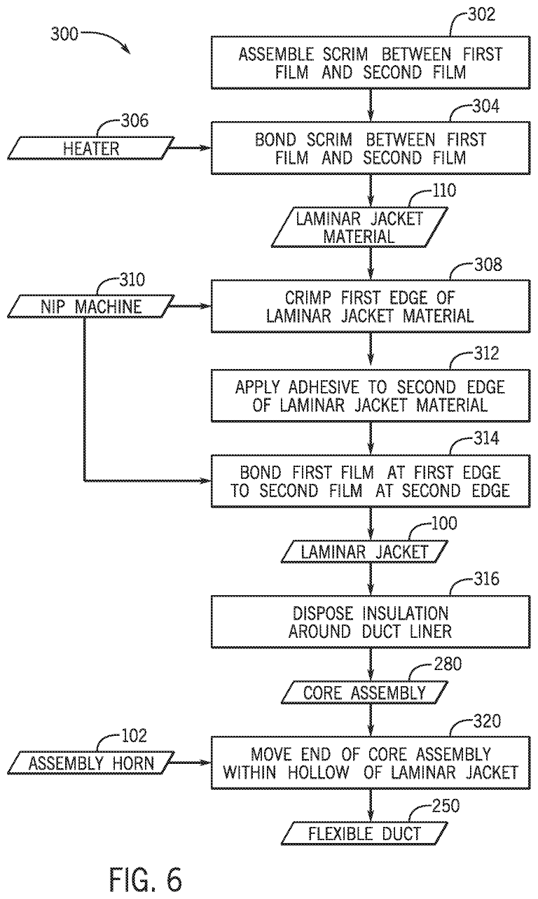

FIG. 6 is a flow diagram illustrating an embodiment of a process 300 for constructing the flexible duct 250 having the laminar jacket 100, in accordance with an aspect of the present disclosure. The steps illustrated in the process 300 are meant to facilitate discussion and are not intended to limit the scope of this disclosure, because additional steps may be performed, certain steps may be omitted, and the illustrated steps may be performed in an alternative order or in parallel, where appropriate. Moreover, the following discussion references element numbers used throughout FIGS. 1-5.

The illustrated embodiment of the process 300 begins with assembling (block 302) the scrim 112 between the first film 114 and the second film 118. As mentioned above with reference to FIG. 3, the adhesive 150 may be applied to the first film 114, the second film 118, and/or the scrim 112 before the scrim 112 is positioned between the films 114, 118. With the adhesive in place, the process 300 next includes bonding (block 304) the scrim 112 between the first film 114 and the second film 118. In some embodiments, pressure may be applied to the first film 114 and/or the second film 118 to compress the scrim 112 in place. Additionally, in some embodiments, a heater 306 or oven may be used to direct heat to the adhesive 150, thereby reducing a cure time and/or enhancing sealing properties of the bond formed by the adhesive 150. In some embodiments in which the adhesive 150 is a water-based glue, the heater 306 facilitates removal of water from the adhesive 150 that increases a tackiness of the adhesive 150. Once the adhesive 150 is set, the resulting laminar jacket material 110 discussed above with reference to FIG. 3 is formed. By forming the laminar jacket material 110 before forming the laminar jacket 100, a bulk amount of the laminar jacket material 110 may be efficiently prepared for later production of laminar jackets 100.

To adapt the laminar jacket material 110 to form high-reliability linear seams 220, the present embodiment of the process 300 includes crimping (block 308) the first edge 182 of the laminar jacket material 110 to form the crimp 180 discussed above with reference to FIG. 4. The crimp 180 may be formed with a nip machine 310 or biting edge machine, which bends the first edge 182 of the laminar jacket material 110 into a target shape. In some embodiments, the crimp 180 may be formed before the adhesive 150 between the layers of the laminar jacket material 110 is fully set to enable setting of the adhesive 150 to retain the crimp 180 in the target shape. Moreover, in some embodiments, both the first edge 182 and the second edge 192 may include the crimp 180 having any respectively suitable and/or corresponding target shape, in some embodiments.

The process 300 also includes applying (block 312) the adhesive 150 to the first film 114 at the second edge 192 of the laminar jacket material 110. For example, the adhesive 150 may be applied in liquid form with a hot spray gun or as a double-backed adhesive strip. In other embodiments, the adhesive 150 may additionally or alternatively be applied to the second film 118 at the first edge 182 of the laminar jacket material 110. Then, the process 300 includes bonding (block 314) the first film 114 at first edge 182 to the second film 118 at the second edge 192 via the adhesive 150 therebetween to form the laminar jacket 100 with the linear seam 220. In some embodiments, the linear seam 220 may be further secured by passing the linear seam 220 through the nip machine 310 or another suitable pressure sealing device. As discussed above, the laminar jacket 100 having the linear seam 220 is therefore pre-formed without the insulation 104 or the duct liner 106 within the hollow 230 of the laminar jacket 100. Moreover, compared to complicated helically-wrapped jacket formation processes, the laminar jacket 100 may be formed at a speed that is three, five, ten, or more times as fast.

Independent from the steps for forming the laminar jacket 100, the process 300 may include disposing (block 316) the insulation 104 around the duct liner 106 to form the core assembly 280, as discussed above with reference to FIG. 5. Then, the process includes moving (block 320) the longitudinal end of the core assembly 280 within the hollow 230 of laminar jacket 100. In some embodiments, the assembly horn 102 may be used to facilitate compression of the core assembly 280 within the laminar jacket 100. For example, the assembly horn 102 may be a tapered, hollow tube with an outer diameter that is slightly less than an inner diameter of the laminar jacket 100. The longitudinal end of the laminar jacket 100 may then be placed over an outer surface of a first end of the assembly horn 102, and an entire length of the laminar jacket 100 may be compacted onto the first end of the assembly horn 102. Additionally, the longitudinal end of the core assembly 280 may be fit within the through-hole 108 of the assembly horn 102 at a second end of the assembly horn 102. Then, the core assembly 280 may be moved within the through-hole 108, to the first end of the assembly horn 102, and out of the assembly horn 102 as the laminar jacket 100 is moved off the assembly horn 102. As such, the insulation 104 of the core assembly 280 may be compressed and interference-fit within the hollow 230 of the laminar jacket 100 to form the flexible duct 250 having the core assembly 280 retained within the laminar jacket 100 without adhesive.

Accordingly, embodiments discussed herein are directed to laminar jackets 100 for flexible ducts 250 having the linear seam 220 that provides for more efficient manufacturing and increased strength compared to helically-wrapped jackets. The laminar jacket 100 may be constructed from the laminar jacket material 110, which may include a metalized polyester first film 114, a clear polyester second film 118, and a fiberglass scrim 112 adhered between the films 114, 118. Then, the adhesive 150 may be applied on one or both edges 182, 192 of the laminar jacket material 110, and the laminar jacket material 110 may be rolled into a tubular shape in which the first edge 182 and the second edge 192 seal together. In some embodiments, the laminar jacket 100 may be rapidly constructed at a rate that is ten times faster than a similar jacket constructed by helically wrapping individual layers of material over a mandrel. For example, in contrast to using small strips of material that are several inches wide, the laminar jacket 100 may be rapidly constructed by forming the single linear seam 220 in the laminar jacket material 110, which has the second width 144 that corresponds to the desired circumference of the laminar jacket 100 plus its overlap distance 194. Additionally, the laminar jacket 100 disclosed herein may use a reduced amount of material compared to helically-wrapped jackets that include a considerable number of overlaps between adjacent windings of the material. Further, the laminar jacket 100 having the single linear seam 220 advantageously has a seam length that is less than an effective seam length of the helically-wrapped jackets, thereby improving operation of the HVAC unit 12 by reducing potential sites for seal degradation.

While only certain features and embodiments of the present disclosure have been illustrated and described, many modifications and changes may occur to those skilled in the art, such as variations in sizes, dimensions, structures, shapes and proportions of the various elements, values of parameters, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described, such as those unrelated to the presently contemplated best mode of carrying out the present disclosure, or those unrelated to enabling the claimed disclosure. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A laminar jacket for a flexible duct of a heating, ventilation, and/or air conditioning (HVAC) system, comprising:
a first film defining an outer surface of the laminar jacket;
a second film defining an inner surface of the laminar jacket;
a scrim retained between the first film and the second film; and
a longitudinally-extending seam between the first film and the second film that retains the laminar jacket in a tubular shape, wherein the inner surface of the laminar jacket defines a hollow that is configured to receive insulation and that does not have the insulation disposed therein.

2. The laminar jacket of claim 1, wherein the inner surface of the laminar jacket defines an inner diameter that is smaller than an outer diameter of the insulation before the insulation is disposed within the hollow of the laminar jacket.

3. The laminar jacket of claim 1, wherein the second film is configured to retain the insulation within the hollow of the laminar jacket via friction.

4. The laminar jacket of claim 1, wherein the laminar jacket is configured to retain the insulation within the hollow of the laminar jacket without adhesive.

5. The laminar jacket of claim 1, wherein the inner surface of the laminar jacket overlaps the outer surface of the jacket at the longitudinally-extending seam.

6. The laminar jacket of claim 1, wherein the first film is metalized polyester film, and wherein the second film is clear polyester film.

7. The laminar jacket of claim 1, wherein the first film or the second film is metalized polyester film, clear polyester film, colored polyester film, polyethylene film, or kraft paper.

8. The laminar jacket of claim 1, wherein the laminar jacket is configured to receive a core assembly having the insulation disposed around a duct liner.

9. The laminar jacket of claim 8, wherein the laminar jacket is configured to be disposed on an outer surface of an assembly horn having a through-hole defined therein, and wherein the core assembly is configured to be moved within the through-hole to compress the core assembly for insertion within the hollow of the laminar jacket.

10. A flexible duct of a heating, ventilation, and/or air conditioning (HVAC) system, comprising:
a duct liner;
insulation disposed around the duct liner; and
a laminar jacket retaining the insulation therein, wherein the laminar jacket includes:
a first film defining an outer surface of the laminar jacket;
a second film defining an inner surface of the laminar jacket;
a scrim retained between the first film and the second film; and
a longitudinally-extending seam between the first film and the second film that retains the laminar jacket in a tubular shape, wherein the second film is in direct contact with the insulation of the flexible duct.

11. The flexible duct of claim 10, wherein the second film is configured to retain the insulation within the laminar jacket via friction.

12. The flexible duct of claim 10, wherein the insulation has an unassembled outer diameter before the insulation is retained within the laminar jacket, the second film defines an inner diameter of the laminar jacket, and the unassembled outer diameter is larger than the inner diameter.

13. The flexible duct of claim 12, wherein the laminar jacket is formed from a laminar jacket material having the first film, the scrim, and the second film, and wherein a width of the second film of the laminar jacket material defines the inner diameter of the laminar jacket.

14. The flexible duct of claim 10, wherein the scrim is encapsulated between the first film and the second film.

15. The flexible duct of claim 10, wherein second film is clear polyester film, and wherein the first film is metalized polyester film that defines a vapor barrier of the laminar jacket configured to shield the insulation from moisture within air around the flexible duct.

16. A method of constructing a flexible duct for a heating, ventilation, and/or air conditioning (HVAC) system, comprising:
bonding a scrim between a first film and a second film to form a laminar jacket material having a first longitudinally-extending edge and a second longitudinally-extending edge;
bonding the first film at the first longitudinally-extending edge to the second film at the second longitudinally-extending edge to form a laminar jacket, wherein the laminar jacket is a tube defining a hollow therein; and
disposing a core assembly including insulation within the hollow of the laminar jacket to form the flexible duct.

17. The method of claim 16, wherein the second film is in direct contact with the insulation of the flexible duct.

18. The method of claim 16, wherein the laminar jacket is configured to retain the insulation within the hollow via an interference fit.

19. The method of claim 16, wherein the core assembly comprises a duct liner and the insulation, and wherein the method includes disposing the core assembly within the hollow by:
disposing the insulation around the duct liner to form the core assembly; and
moving a longitudinal end of the core assembly within a longitudinal opening of the hollow.

20. The method of claim 19, comprising moving the longitudinal end of the core assembly within the longitudinal opening of the hollow by:
disposing the laminar jacket on an outer surface of a first end of an assembly horn;
disposing the longitudinal end of the core assembly within a second end of the assembly horn, which is opposite the first end; and
moving the longitudinal end of the core assembly to the first end of the assembly horn and out of the assembly horn as the laminar jacket is moved off the first end to compress the core assembly within the hollow of the laminar jacket.

21. The method of claim 16, comprising bonding the scrim between the first film and the second film to form the laminar jacket material by:
disposing the scrim onto one of the first film and the second film;
applying adhesive to the scrim; and
disposing the other one of the first film and the second film onto the scrim.

22. The method of claim 16, comprising bonding the first film to the second film to form the laminar jacket by:
applying adhesive to the second longitudinally-extending edge of the laminar jacket material;
disposing the first longitudinally-extending edge of the laminar jacket material over the second longitudinally-extending edge to form a longitudinally-extending seam between the first film and the second film; and
compressing the longitudinally-extending seam with a nip machine.

23. The method of claim 16, wherein the laminar jacket includes a vapor barrier configured to shield the insulation from moisture within air around the flexible duct.
